(19) United States
(12) Patent Application Publication
(10) Pub. No.: US 2023/0079775 A1
(43) Pub. Date: Mar. 16, 2023

(54) DEEP NEURAL NETWORKS-BASED VOICE-AI PLUGIN FOR HUMAN-COMPUTER INTERFACES

(71) Applicants: Jay N. Ruparel, PALO ALTO, CA (US); Shweta J. Ruparel, PALO ALTO, CA (US); Kuldeep Yadav, BENGALURU (IN)

(72) Inventors: Jay N. Ruparel, PALO ALTO, CA (US); Shweta J. Ruparel, PALO ALTO, CA (US); Kuldeep Yadav, BENGALURU (IN)

(21) Appl. No.: 17/857,932

(22) Filed: Jul. 5, 2022

Related U.S. Application Data
(60) Provisional application No. 63/218,281, filed on Jul. 3, 2021.

(51) Int. Cl. G06F 40/35; G06F 40/279; G10L 13/02; G10L 25/78; G10L 21/0208; G06F 40/40; G10L 17/22

(52) U.S. Cl. CPC G06F 40/35; G06F 40/279; G10L 13/02; G10L 25/78; G10L 21/0208; G06F 40/40; G10L 17/22; G10L 2025/783

(57) ABSTRACT

A method for implementing channels with a voice-based artificial intelligence (AI) functionality that enables human users to interact and transact with a business entity through one or more natural voice conversations; implementing a user identification and authentication on the voice input from the voice channel; generating a transcription of the voice input; passing the transcript to a natural language understanding (NLU) engine and with the NLU engine: implementing machine learning algorithm for intent, entity, and context identification on the input; with the dialogue manager, understanding the conversation state, predicting the right action and response based on the intent, entity, context, and the user emotion; with a natural language generation module that comprises a natural language generation functionality: implementing a computerized voice generation, generating a voice output comprising a relevant response to the voice input, and providing a voice output channel; and providing the voice output to user.

### CLAIM OF PRIORITY

This application claims priority to U.S. Provisional Patent Application No. 63/218,281, filed on 3 Jul. 2021, and titled AI SYSTEMS FOR VOICE BASED FUNCTIONALITIES. This provisional application is hereby incorporated by reference in its entirety.

### FIELD OF INVENTION

This application relates to utilization of machine learning for computerized natural language processing/generation and, more specifically to a deep neural networks-based voice-AI plugin for human-computer interfaces.

### BACKGROUND

Entities that interface with human users (e.g. restaurant entities, catalogue-based entities, etc.) interact and transact with users using different channels. These can include, inter alia: websites, mobile applications, third-party websites and applications, telephones, drive-through windows, etc. These channels have allowed for easy interaction and transaction of information, goods, services, and payment and have become more effective in the value they provide over the years. However, these channels are not naturally equipped with the capabilities for one or both sides of the interaction channel to be a non-human entity or driven by a bot.

General purpose conversational AI systems are limited in their functionality, effectiveness, and performance in comparison to what is expected by entities like restaurants and their customers. To allow for this, the channel needs to be enabled with the domain like restaurant specific Voice-AI technology so that a non-human entity can initiate, manage, and complete interactions and transactions with a human or another non-human entity.

Accordingly, improvements to the current state of the art are desired. The present invention provides Voice-AI technology so that entities can interact and transact with their customers using automated AI powered voice-bots as an augmentation or replacement to the services provided by human staff.

### SUMMARY OF THE INVENTION

A method for implementing channels with a voice-based artificial intelligence (AI) functionality that enables human users to interact and transact with a business entity through one or more natural voice conversations; implementing a user identification and authentication on the voice input from the voice channel; generating a transcription of the voice input; passing the transcript to a natural language understanding (NLU) engine and with the NLU engine: implementing machine learning algorithm for intent, entity, and context identification on the input; with the dialogue manager, understanding the conversation state, predicting the right action and response based on the intent, entity, context, and the user emotion; with a natural language generation module that comprises a natural language generation functionality: implementing a computerized voice generation, generating a voice output comprising a relevant response to the voice input, and providing a voice output channel; and providing the voice output to user.

### BRIEF DESCRIPTION OF THE DRAWINGS

The present application can be best understood by reference to the following description taken in conjunction with the accompanying figures, in which like parts may be referred to by like numerals.

FIG. 1 illustrates an example Voice Ordering AI system, according to some embodiments.

FIG. 2 illustrates an example process for implementing channels with Voice-AI functionality so that users can interact and transact with a business entity through natural voice conversations, according to some embodiments.

FIG. 3 illustrates an example schematic of a food ordering use schematic, according to some embodiments.

FIG. 4 illustrates an example process for implementing a Deep Learning Based Natural Language Understanding (DLNLU) Engine, according to some embodiments.

FIG. 5 illustrates an example process for a conversation using a DLNLU and a RDM, according to some embodiments.

FIG. 6 illustrates an example process for implementing a restaurant dialog manager, according to some embodiments.

FIG. 7 illustrates an example process for implementing a conversational AI-based dialog and interaction manager, according to some embodiments.

FIG. 8 illustrates an example process for implementing an ML-powered Menu and Upsell Manager (MUM), according to some embodiments.

FIG. 9 depicts an exemplary computing system that can be configured to perform any one of the processes provided herein.

The Figures described above are a representative set and are not an exhaustive with respect to embodying the invention.

### DESCRIPTION

Disclosed are a system, method, and article of manufacture for various AI voice-based functionalities. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Deep learning is part of a broader family of machine learning methods based on artificial neural networks with representation learning. Learning can be supervised, semi-supervised or unsupervised.

Key-value pair term can include a key that is the log feature or log attribute, and a value(s) that is the log data. In some examples, a one-to-many key-values relationship can be used.

Machine Learning can be the application of AI in a way that allows the system to learn for itself through repeated iterations. It can involve the use of algorithms to parse data and learn from it. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Natural language generation (NLG) is a software process that produces natural language output.

Natural language processing, a branch of artificial intelligence concerned with automated interpretation and generation of human language.

Natural-language understanding (NLU) is a subtopic of natural-language processing in artificial intelligence that deals with machine reading comprehension.

Relationship can be the mapping of disjoining log data groups to log features or attributes.

Voiceprint is a digital model of the unique vocal characteristics of an individual. It is a distinctive pattern of certain voice characteristics that is spectrographically produced, and can later be used for voice authentication and biometrics.

### Example Systems and Methods

An AI system that takes drive-thru orders and incoming phone orders, interacting with humans and other AI systems to receive and process food orders.

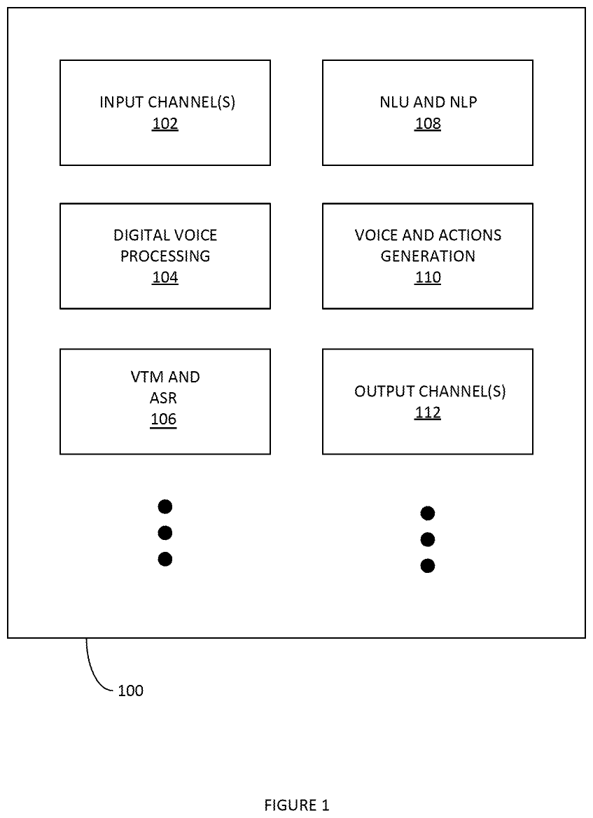

FIG. 1 illustrates an example Voice Ordering AI system 100, according to some embodiments. Voice Ordering AI system 100 can enable end to end food ordering for restaurants. Voice Ordering AI system 100 includes input channel(s) 102. Input channels 102 include the various sources through which the customers can interact with the restaurant's food ordering system. These include, inter alia:

Dialing a phone number to place a food order;

Speaking to a Voice-AI enabled touch point like a drive-thru box, menu board etc.

Digital Voice Processing 104 obtains the voice input from the input channels is then processed to eliminate any background noise and amplify voice inputs (e.g. if the voice inputs are below a certain threshold).

Voice-to-Meaning (VTM) and Automatic Speech Recognition (ASR) 106 obtained the processed voice input and generates meaning from the speech directly. Voice-to-Meaning (VTM) and Automatic Speech Recognition (ASR) 106 converts the voice to text and meaning which can then be passed to the NLU and NLP engine for processing.

Deep Neural Networks-Based Voice-AI Plugin for Human-Computer Interfaces

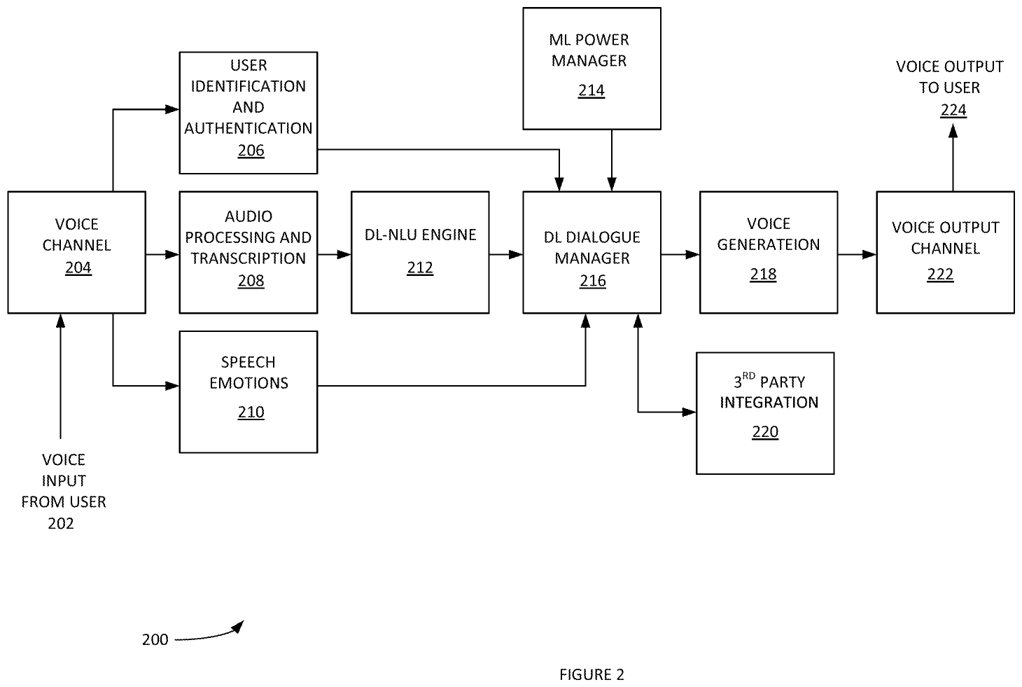

FIG. 2 illustrates an example process 200 for implementing channels with Voice-AI functionality so that users can interact and transact with a business entity through natural voice conversations, according to some embodiments. In step 202, a user provides a voice input. In one example, this can be a phone call input from a user (e.g. placing an order with a business like a restaurant via a phone call, etc.). In step 204, voice input in received and carried by a voice channel. A voice channel includes any customer-entity interaction channel which uses a microphone or similar voice input device to capture the customer audio. Examples include entity ordering systems like restaurant drive-thru systems, phones, websites, kiosks enabled with voice input functionality etc.

As shown, process 200 then proceeds to three different blocks. In a first block, process 200 implements user identification and authentication. This can be implemented, through voiceprint that enables process 200 to identify the user.

In a second block, process 200 can implement audio processing and transcription. Here, process 200 can amplify the voice signal lift rate as being below a specified threshold and then convert that audio to text, which can then be passed to a NLU engine.

In a third block, process 200 implements speech emotion(s) identification(s). Through the audio, process 200 captures the emotion that can then be fed into a dialogue manager to then structure the conversation and frame the responses based on the input that has been received from the emotion.

Accordingly, in step 206, process provides user identification and authentication on the output of step 204. In step 208, process provides audio processing and transcription on output of step 204. In step 210, process 200 determines speech emotions of user from output of step 204.

Process 200 can provide a deep learning based natural language understanding engine. Process 200 can detect the intents and entities and understands what the user wishes to say. This can be specifically trained based on a restaurant use case. Process 200 can provide a model on specific dataset so that it is able to capture the intent, entities, contexts, and all of various parameters.

A dialogue manager can be implemented. The dialogue determines the most suitable response for the user's query or trends. Based on the intents and entities that are captured from a review engine, these can be passed to a dialogue manager and a most appropriate response is identified.

The deep learning technologies can use training samples of input example conversations. The training samples can be various relevant utterances based on the domain, specific use case and conversational context (e.g. from a restaurant/customer dialogue set, etc.).

Accordingly, in step 212, process 200 implements a DL-NLU engine on output of step 208. In step 214, process 200 implements a machine learning (ML) powered menu and upsell manager. The ML module can read the training data for a particular manual/context and then use this for ML training for effective menu or catalog management and upselling.

In step 216, process 200 implements a DL dialogue manager output of step 206, 212, 210, 214 and 220 (e.g. 3^{RD} party integration, etc.). In step 218, process 200 implements voice generation. In step 222, process 200 can provide a voice output channel. In step 224, the voice output to user is provided to the user.

In some embodiments, process 200 provides a method to build voice-enabled/enabling websites and/or applications while allowing a business entity (e.g. a restaurant or other businesses that performs user interactions for voice orders, etc.) to retain direct access to their customers and control their digital experience. Process 200 plugs into existing websites and mobile applications to make them voice-enabled allowing for natural language voice conversations and transactions in multiple languages. Process 200 can integrate a single line code to their existing websites and mobile applications to voice-enable them.

The plugin of process 200 adds a custom voice interface to the website and mobile applications and is powered by a Deep Learning Natural Language Understanding (DLNLU) engine trained on a Restaurant Domain Language Model (RDLM). The plugin allows the users to seamlessly switch between voice and conventional (e.g. click and touch) interfaces.

The key building blocks of process 200 can be as follows. Process 200 can provide a voice interface. The voice interface is customized to match the parent website's design theme and requirements through CSS and JavaScript®.

Process 200 can provide a voice and transcript layer. This layer takes spoken audio as input, processes it, and transcribes it into text. DLNLU Engine 212 can extract intents, entities, context, from the recognized text.

The Restaurant Dialogue Manager (RDM) can provide the intelligence behind the entire conversation. RDM understands the contexts of the conversation and identifies the most appropriate response for the user's utterance. RDM block integrates with third-party systems (e.g. POS, CRM, payment, etc.) and provides the required inputs for processing a transaction.

An RDM block also integrates with ML based Menu and Upsell Manager (MUM) to check the relevant menu options and identify the most appropriate response. The text response from RDM then goes through the Natural Language Generation (NLG) layer which generates audio from the text input, which can then be played back on the website or mobile application. The DLNLU engine also sends a response back to the website or mobile app with the required CSS and JavaScript® tags to perform the required actions on the website or mobile app (e.g. search items, add items to cart, show cart details, checkout, etc.).

In one example, process 200 can be utilized for analysis and managing a conversation regarding food ordering from a restaurant. Here, process 200 can manage a POS system through which the user can complete the payment and complete order. Process 200 can be used for the classification of user intents and identification of relevant entities (e.g. from a food order at a restaurant, etc.). Process 200 can be used to understand the very complex natural language ways that users may phrase a request and being able to understand the actual intent that the user has for the request. Process 200 can identify the different entities in play as well. Process 200 can utilize the deep learning models for these purposes.

In one example, process 200 can provide various restaurant phone systems and other ordering channels with a voice-AI functionality. Users can interact and transact with the restaurants through natural voice conversations. In this example use case, process 200 handles incoming phone orders and orders through other ordering channels (e.g. drive-through restaurants, kiosks, menu boards, QR code-based ordering systems, etc.) by interacting with customers and other systems.

The above provided components can be used by process 200 to enable end-to-end food ordering for restaurants. In this example, process 200 can include an input channel. The input channels include the various sources through which the customers can interact with the restaurant's food ordering system. These include, inter alia: dialing a phone number to place a food order; speaking to a Voice-AI enabled touchpoint like a drive-thru box, menu board, kiosks, etc.

Process 200 can provide a voice and transcript layer. The voice input from the input channels is processed to eliminate any background noise and amplify voice inputs if they are below a certain threshold. After the voice input is processed, it goes through the transcript layer which transcribes the voice to text and is then passed to the DLNLU engine for processing.

The DLNLU Engine is now discussed. The output from the transcript layer is passed to the DLNLU engine to extract further meaning in the form of intents, entities, context, and emotions. The extracted meaning elements are then passed to the RDM to perform the required action/transaction and identify the most suitable response for the customer's input.

The RDM block also integrates with a ML based Menu and Upsell Manager (MUM) to check the relevant menu and upsell options and identify the most appropriate response. The response in the form of text, as well as other actions from the RDM, is then passed through the NLG layer to convert the output to voice so that the same can be executed or played back to the user.

Process 200 can use various conversation steps. For example, when a user converses with the system to place an order for pickup/delivery, they can ask for various menu items, check the available modifiers (e.g. serving size, ingredients, other customizations), and add the required items along with modifiers to the cart. The user can then add/remove/update any of the items available in the cart if required. Once they've added the required items to the cart, the checkout conversation flow guides the users to navigate and provide the required customer and payment details for the order. After the required details are received, the order details are sent to the third-party systems (e.g. POS, CRM, etc.) and the user is intimated about the order confirmation and expected fulfilment time.

Customer Relationship Management (CRM) operations implemented with process 200 is now discussed. It is noted that the DLNLU engine supports various CRM-related use cases. Example CRM-related uses cases are now discussed. These can include handling general queries (e.g. generic customer queries for a restaurant like its location, opening hours, table availability, etc.). Process 200 can implement reservations and scheduling (e.g. queries for checking and confirming table reservations, etc.).

Process 200 can provide loyalty program management. Process 200 can provide customers status of their points/tiers, proactively providing relevant offers based on loyalty scores and profile, allowing redemption/usage of loyalty scores, etc. Process 200 can implement feedback and surveys. These can include managing conversations for obtaining feedback from customers on their dine-in or food delivery experiences.

Process 200 can provide promotions and lead generation/qualification. Process 200 can manage conversations for launching/promoting offers, new product launches, campaigns, etc. Other Use Cases of the DLNLU engine also supports various restaurant operations-related use cases, some of which are listed below. For example, DLNLU engine can support conversations to manage and execute orders by restaurant staff. DLNLU engine can support conversations to manage menu items by restaurant staff. These examples are provided by way of example and not of limitation.

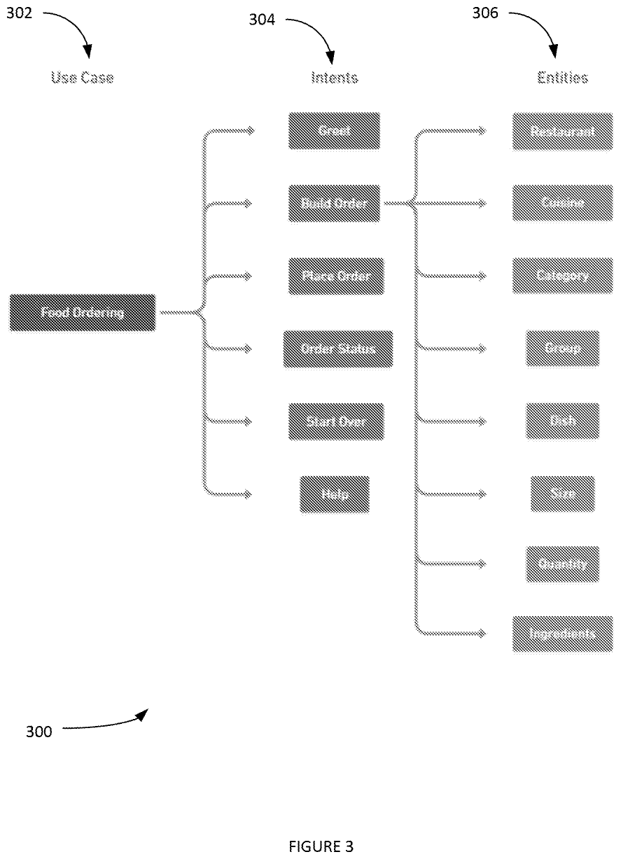

FIG. 3 illustrates an example schematic of a food ordering use schematic 300, according to some embodiments. Food ordering use case 302 encompass the functionality used to order food for delivery/pickup from nearby restaurants. Food ordering use case 302 lists example food ordering specific intents 304 that are included:

<greet>—User wants to start a conversation;

<inquire_item>—User wants to inquire about a category/group/item from the menu;

<ordering intents>—User can add the required quantity, size of items into the cart;

<customization intents>—User can add, remove, modify ingredients of an item;

<update item intents>—User can change quantity, size, modifications of an item after they have been added to the cart;

<show_cart>—User wants to check the already available items in the cart;

<ask_price>—User wants to inquire about the price details for an item;

<ask_calories>—User wants to inquire about the calorie details for an item;

<ask_recommendations>—User wants to know the recommended items from a category/group in the menu;

<order_type>—User wants to provide the pickup/delivery details;

<allergy>—User wants to provide allergy related information for the order;

<special_instructions>—User wants to provide special instructions to the kitchen for the order;

<half and half>—For specific items, user wants to modify the two halves of the item separately (Example—Toppings on a Pizza, Stuffing in a sandwich, etc.);

<item part>—User only provides a part of the item name which could match with multiple items from the menu;

<build your own item>—User wants to add a build your own item to the order by providing the relevant modifiers;

<combo items>—User wants to add combo items to the order by selecting from the available choice options;

<start_over>—User wants to abandon current selections and restart the ordering process;

<exit>—User wants to end the current conversation;

<help>—User is confused or needs instructions on how to proceed; and

<unsupported>—User is talking about something other than food ordering.

The following entities 308 can be supported:

<restaurant>—The name of a restaurant and location

<cuisine>—The name of a cuisine

<category> and <group>—The name of a food category or group on a restaurant menu

<dish>—The name of a dish on a restaurant menu

<option>—The name of an available option (customization, add-on, etc.) for a dish

<size> and <quantity>—The size and quantity for the selected dish.

The Restaurant NLU and NLP engine supports various CRM related use cases as well. These can include, inter alia:

General queries—Generic customer queries for a restaurant like it's location, opening hours, table availability, etc.;

Reservations and Scheduling—Queries for checking and confirming table reservations, etc.;

Loyalty Program Management—Providing customers status of their points/tiers, proactively providing relevant offers based on loyalty scores and profile, allowing encashment/usage of loyalty scores etc.;

Feedback and Surveys—Conversations for getting feedback from customers on their dine-in or food delivery experiences;

Promotions and Lead Generation/Qualification—Conversations for launching/promoting offers, new product launches, campaigns, etc.; and

Restaurant Operations—Conversations to manage and execute orders within the restaurant;

It is noted that each of these use-cases are enabled by training specified deep learning algorithms on relevant real-world conversation examples and integrations with third party systems that the partner restaurants use for extracting relevant information.

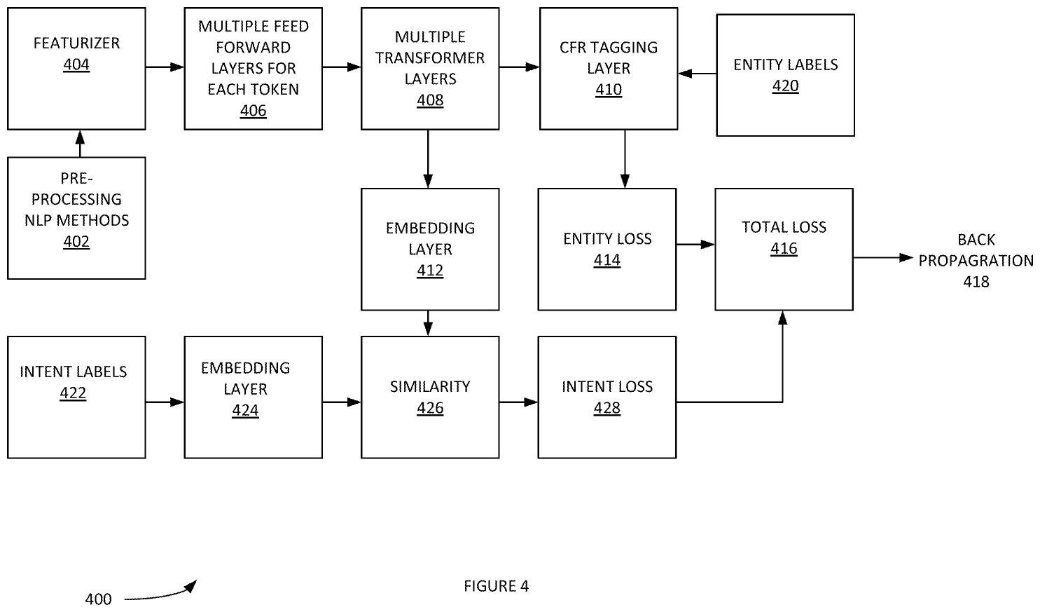

FIG. 4 illustrates an example process 400 for implementing a Deep Learning Based Natural Language Understanding (DLNLU) Engine, according to some embodiments. In step 402, process 400 can implement pre-processing NLP methods. Process 400 can implement a featurizer in step 404. A featurizer process can transforms tokenized text into a machine-readable format. Process 400 can implement multiple feed forward layers for each token in step 406. Process 400 can implement multiple transformer layers in step 408.

Process 400 can implement a conditional random fields (CRF) tagging layer in step 410. Process 400 can implement an embedding layer in step 412. Process 400 can implement various entity loss operations in step 414. Process 400 can implement various total loss operations in step 416. Process 400 can implement back propagation in step 418. Process 400 can provide entity labels in step 420. Intent labels can be generated in step 422. In step 424, process 400 can implement an embedding layer. Similarity values can be determined in step 426. Intent loss can be determined in step 428.

Additional embodiments of process 400 are now discussed. DLNLU engine can be a lightweight, multilayer transformer architecture for creating restaurant domain language model (RDLM). It is noted that specific models for other industries can be utilized in other examples.

DLNLU handles both intent classification and entity recognition together. The input received by process 400 from the transcript layer undergoes various NLP techniques. These operations are now provided. Process 400 can tokenize to split the text into small tokens.

Process 400 can provide a vector representation using different featurizers like, inter alia: vector representation of user utterance using regular expression; vector representation of user utterance by moving a sliding window for every token and checking the placement of the token and relation between the current token, before and after tokens; and/or vector representation of user utterance by creating a bag-of-words and character n-gram representation. The output from the above processing steps by process 400 becomes the inputs to DLNLU engine.

DLNLU engine can then extract intents, entities, context, and emotions. DLNLU engine includes multiple feedforward layers with shared weights and required output dimensions. On top of the transformer layer the entities are passed to Conditional Random Fields (CRF) layer for comparing the output from the transformer block to create entity losses. The output from various feed forward layers is fed to the multi layer transformer block and various losses like entity loss, intent loss, mask loss, total loss are computed and the model can be trained to minimize the loss and be able to predict with very high level of accuracy. Several hyperparameters are tuned to generate a high level of accuracy for intent classification and entity recognition. Some of these include, inter alia:
Number of epochs—Epochs is number of complete passes through the training data. One epoch is equal to one forward pass and one backward pass of all the training examples;

Hidden layer sizes—This parameter controls how many feed forward layers and their output dimensions for user utterances and intents; and/or

Number of transformer layers—This parameter sets the number of transformer layers to be used.

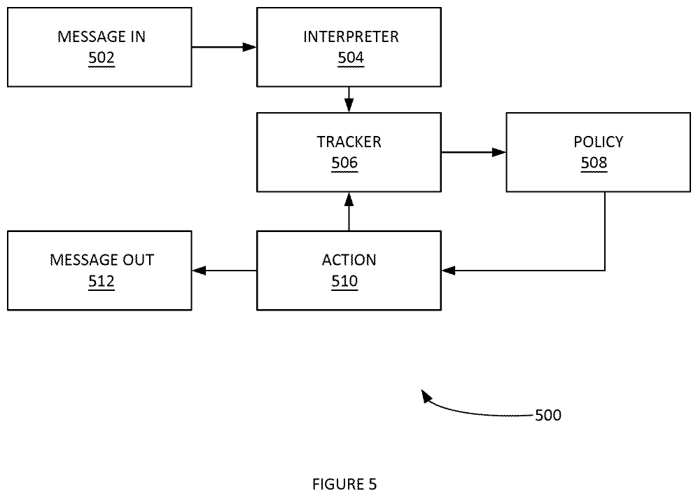

FIG. 5 illustrates an example process 500 for a conversation using a DLNLU and a RDM, according to some embodiments to understand the high-level flow of the conversation using DLNLU and RDM. As shown in FIG. 5, the DLNLU engine is referred to as interpreter 504 and RDM includes tracker 506, policy 508 and action 510. The input message 502 is interpreted by an interpreter 504 to extract intent and entity. It is then passed to the tracker 506. Tracker 506 keeps track of the current state of the conversation. The policy 508 applies the required ML algorithm to determine what should be the reply and chooses action 510 accordingly.

Action 510 updates the tracker 506 to reflect the current state, and passes the response to the NLG layer for generating the audio to be played back to the customer. The RDM also performs the required actions and transactions based on the context of the conversation, like calling third-party APIs to place an order, completing payments, etc. Process 500 outputs message out 512.

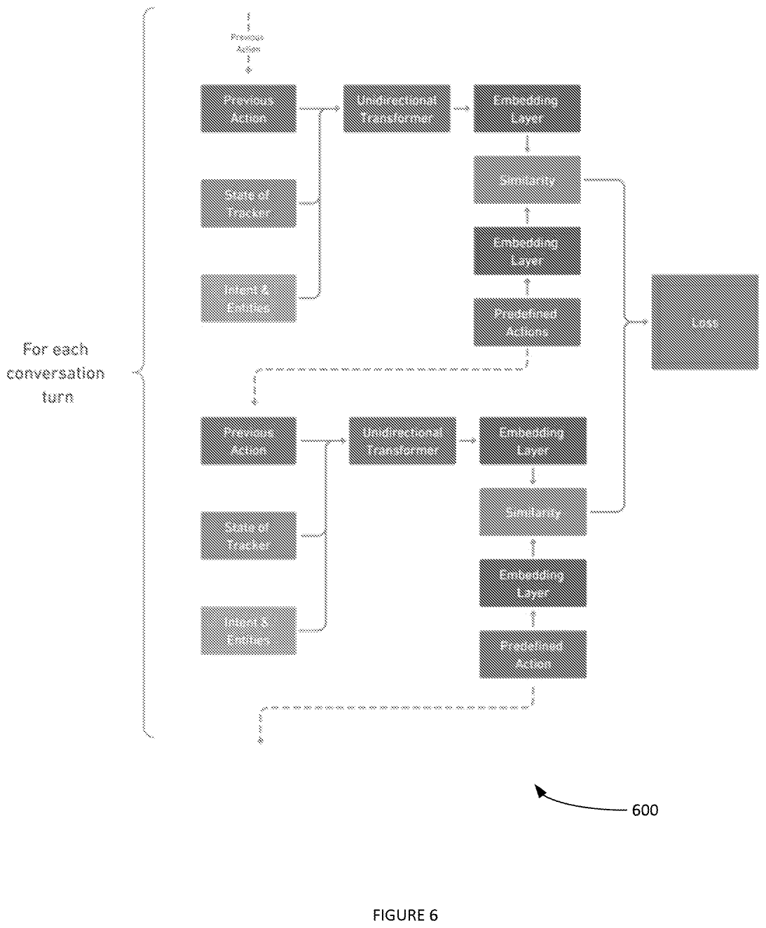

FIG. 6 illustrates an example process 600 for implementing a restaurant dialog manager, according to some embodiments. Deep Learning-based Restaurant Dialogue Manager (RDM) uses a transformer based deep learning technique to pick up conversational patterns from example conversations unlike only the utterance examples used by DLNLU.

Based on the conversation patterns and the current state of the bot, the model predicts the next best action to be performed. Since the model may be able to predict based on various examples of conversation patterns, a developer does not need to program every possible conversation turn. Example hyperparameters listed below are tuned to generate high level of accuracy in predicting actions. These can include, inter alia:
Number of epochs: the number of times the algorithm should pass through the training data. One epoch is considered as one forward pass and one backward pass; and
Max history: this tells the model how deep into the history of conversations it can look while making the prediction.

An action can be as simple as uttering a static response to as complex as searching for multiple entities in a database and returning a series of valid responses to the user. The action can return a list of events and update the tracker's state. The tracker is a stateful component to store all the events and also stores some context variables called slots.

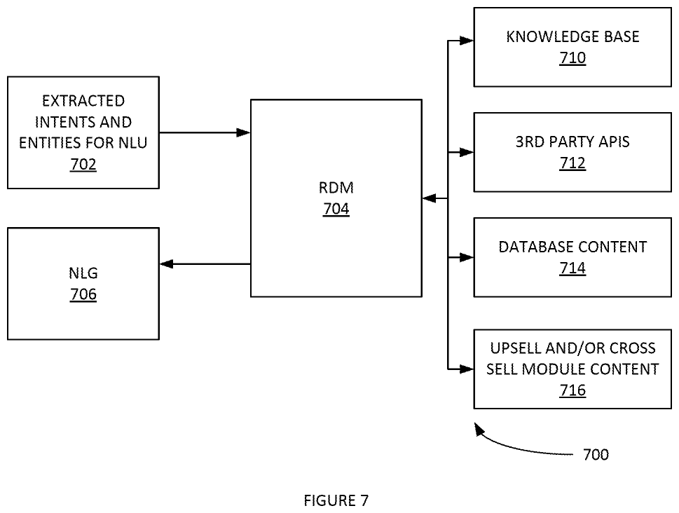

FIG. 7 illustrates an example process 700 for implementing a conversational AI-based dialog and interaction manager, according to some embodiments. Process 700 obtains extracted intents and entities for NLU 702. RDM 704 manages, inter alia: dialog content, dialog state tracker and/or dialog policy. RDM 704 provides output to NLG (e.g. text to speech) 706. RDM 704 takes as input, inter alia: knowledge base 710, 3rd party APIs 712, database content 714, upsell and/or cross sell module content 716.

Conversational AI-based dialog and interaction manager supports multi-lingual, multi-modal, multi-cuisine food ordering, order management and other use cases. Conversational AI-based dialog and interaction manager supports and ensures conversation continuity.

RDM 704 controls how the system navigates between tasks (e.g. how it behaves when required to pause a particular task, switch intent, switch to a different task, and then return to the original user request without losing context, etc.). Conversational AI-based dialog and interaction manager performs specified actions and transactions. The intents and entities along with the context and emotions captured by the DLNLU engine are passed to the RDM 704 to perform the required action.

Example actions can include inter alia:

calling a third-party API to place a food order;

calling a payment gateway to process the payment; and/or

calling a third-party API to check the item availability, etc.

Conversational AI-based dialog and interaction manager can capture follow-up intents for continuous improvements. RDM 704 stores intents that came up during a conversation but were not acted upon immediately. They can later be analyzed to improve the overall conversations. Conversational AI-based dialog and interaction manager supports upsell and/or cross-sell operations. An AI-based dialogue and interaction manager also enables restaurants to upsell and cross-sell menu items based on various configuration rules. It can be configured to, inter alia:

Upsell and/or cross-sell menu items based on existing items in a user's cart or their preferences;

Upsell and/or cross-sell menu items based on the restaurant's recommendations; and

Inform customers about new product launches, sales, etc.

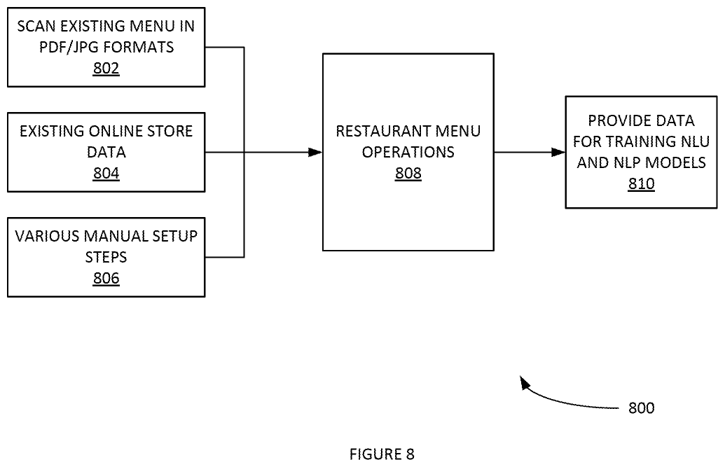

FIG. 8 illustrates an example process 800 for implementing an ML-powered Menu and Upsell Manager (MUM), according to some embodiments. MUM is a machine learning driven menu and catalog management system that reads menu elements from various input sources and auto-configures them smartly based on the context required. MUM allows restaurants to seamlessly set up and maintain the menus and item lists on a MUM platform. In one example, when a new restaurant is onboarded, they have provisions to set up their menu or item list using one or more of the following modules available within MUM.

MUM can include the following functionalities, inter alia:
Image Recognition: through the image recognition (OCR) module, MUM extracts all the items, item categories, groups, price information and ingredients automatically and makes them available for the administrator to seamlessly set up the menu;
Existing Online store: MUM allows restaurants and retailers with existing online stores to import the menu and items to an enterprise's store;
Manual Setup: Restaurant managers also have an option to set up the menus and items manually on MUM. They can add all the required details including menu name, item categories and sub-categories, item image, prices, up-selling options and much more.

MUM also allows the restaurants to keep the menus live depending on the real-world conditions. This includes, inter alia: adding, updating, or deleting any items from the menu; managing the availability of various items at any point of time during the day; updating the prices of various items based on changes; etc. These updates can be made by logging in to the MUM and navigating the portal through conventional keyboard or mouse inputs (Scroll and click) or by using voice commands. MUM also creates the required data template for training the restaurant-specific NLU and NLP models. MUM dynamically identifies the best upselling option to a customer by analyzing multiple data points including item availability, real-time demand, customer's preferences, alternate options available, etc.

More specifically, process 800 can scan existing menu in PDF/JPG formats in step 802. Process 800 can obtain existing online store data in step 804. Process 800 can implement various manual setup steps in step 806. Process 800 can implement/determine a restaurant menu in step 808. Process 800 can provide data for training NLU and NLP models in step 810.

Additional Computing Systems

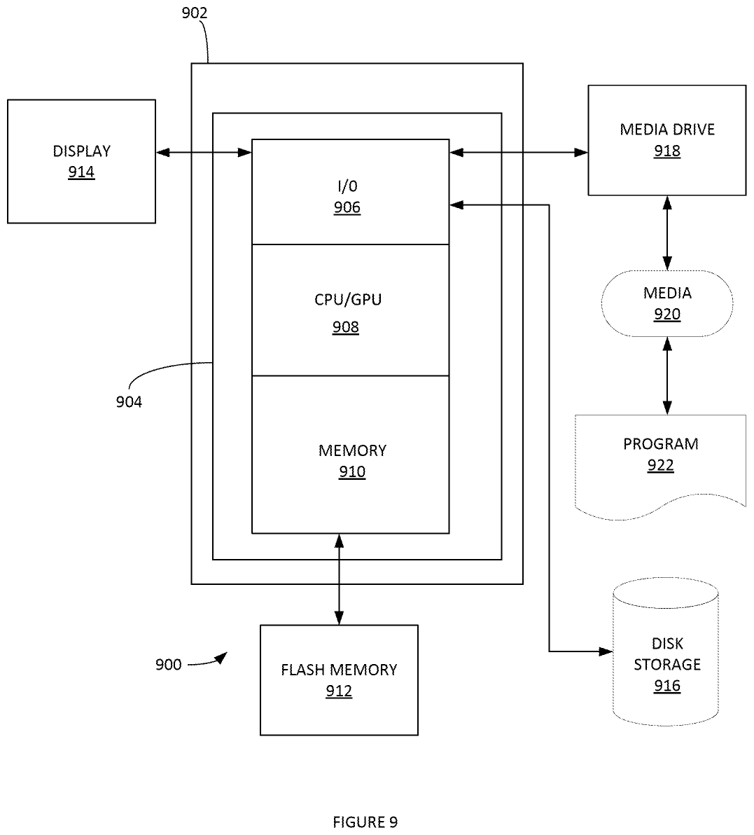

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) and/or graphical processing unit (GPU) 908, and a memory section 910, which may have a flash memory card 912 related to it. The I/O section 906 can be connected to a display 914, a keyboard and/or another user input (not shown), a disk storage unit 916, and a media drive unit 918. The media drive unit 918 can read/write a computer-readable medium 920, which can contain programs 922 and/or databases. Computing system 900 can include a web browser. Moreover, it is noted that computing system 900 can be configured to include additional systems in order to fulfill various functionalities. Computing system 900 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A method for implementing channels with a voice-based artificial intelligence (AI) functionality that enables human users to interact and transact with a business entity through one or more natural voice conversations, comprising:
receiving a voice input from a user, wherein the voice input is in a digital format;
carrying the voice input by a voice channel, wherein the voice channel comprises user-entity interaction channel which uses an audio input device like microphone to capture the voice input;
implementing a user identification and authentication on the voice input from the voice channel;
generating a transcription of the voice input;
passing the transcript to a natural language understanding (NLU) engine and with the NLU engine:
implementing machine learning algorithm for intent, entity, and context identification on the input;
with the dialogue manager, understanding the conversation state, predicting the right action and response based on the intent, entity, context, and the user emotion;
with a natural language generation module that comprises a natural language generation functionality:
implementing a computerized voice generation,
generating a voice output comprising a relevant response to the voice input, and
providing a voice output channel; and
providing the voice output to user.

2. The method claim 1, wherein the voice input comprises a real-time streaming of a phone call input from the user.

3. The method of claim 1, wherein the voice input is detected to be below a specified threshold and then implementing a voice signal amplification before converting the voice input to the text.

4. The method of claim 1 further comprising:
implementing a machine learning (ML) powered menu and upsell manager.

5. The method of claim 4, wherein the ML module reads a set of training data for a digital or manual text and then utilizes the digital or manual text for ML training and generates a menu or catalog management and upselling ML model.

6. The method of claim 5, menu or catalog management and upselling ML model is used to check the relevant menu and upsell options and identify an upsell response.

7. The method of claim 6, wherein the response is in the form of a text and is passed to the dialog manager and then to NLG layer to convert the output to the voice output to be output to the user.

8. The method of claim 1, wherein the voice-based AI functionality plugs into a website code such that the web site is voice-enabled allowing for a natural language voice conversation between the user and the entity.

9. The method of claim 1, wherein the voice-based AI functionality plugs into the website with a single line code.

10. The method of claim 1, wherein the voice-base AI functionality plugs into a mobile application such that the mobile application is voice-enabled allowing for the natural language voice conversation between the user and the entity.

11. The method of claim 10, wherein the wherein the voice-based AI functionality plugs into the mobile application with a single line code.

12. The method of claim 1 wherein the voice-enabled conversation comprises a natural language voice conversation in a plurality of languages.

13. The method of claim 1, wherein the voice input is processed to eliminate any background noise.
